(19) United States
(12) Patent Application Publication
(10) Pub. No.: US 2024/0141691 A1
(43) Pub. Date: May 2, 2024

(54) UNIVERSAL DOOR LOCK INDICATING DEVICES, KITS, AND METHODS

(71) Applicants: Zachary Dan Griffith, Herriman, UT (US); Rachelle Lynn Griffith, Herriman, UT (US)

(72) Inventors: Zachary Dan Griffith, Herriman, UT (US); Rachelle Lynn Griffith, Herriman, UT (US)

(21) Appl. No.: 17/979,585

(22) Filed: Nov. 2, 2022

(51) Int. Cl. E05B 17/22; E05B 39/00; E05B 39/04

(52) U.S. Cl. CPC E05B 17/22; E05B 39/005; E05B 39/04; E05B 2047/0069

(57) ABSTRACT

Universal door lock indicating devices, kits, and methods are described. The kits and devices can include a flexible material designed to fit over a deadbolt lock turnpiece, a sensor designed to detect whether the deadbolt lock turnpiece is in a horizontal or vertical position, and a wireless transmitter which can be operatively connected to receive output from the sensor. The methods can include receiving a wireless transmission from a device of the disclosure, and outputting the locked or unlocked status of a deadbolt based upon information in the wireless transmission. The methods can also include fitting a device of the disclosure over a deadbolt lock turnpiece, turning the deadbolt lock turnpiece to lock or unlock a deadbolt operably linked to the deadbolt lock turnpiece, and generating a wireless transmission from the wireless transmitter.

### FIELD

The present disclosure is directed to the field of home security. More particularly, the present disclosure relates to devices, kits, systems, and methods that inform a user of the locked or unlocked status of a deadbolt.

### BACKGROUND

Doors are often left unlocked by other family members such as children. Countless nights, vacations, and outings are disrupted by that eerie feeling that a door may not be locked. Home alarm systems can indicate that doors are closed, but cannot provide information that a deadbolt is actually locked. Electronic door locks can be accessed remotely to physically lock and unlock a deadbolt, but these are expensive and difficult to install.

### SUMMARY

In general, in a first aspect, the disclosure features a device. The device can include a flexible material designed to fit over a deadbolt lock turnpiece, a sensor designed to detect whether the deadbolt lock turnpiece is in a horizontal or vertical position, and a wireless transmitter operatively connected to receive output from the sensor.

In general, in a second aspect, the disclosure features a kit. The kit can include flexible material designed to fit over a deadbolt lock turnpiece, a sensor designed to detect whether the deadbolt lock turnpiece is in a horizontal or vertical position, and a wireless transmitter.

In general, in a third aspect, the disclosure features a method. The method can include receiving a wireless transmission from a device of the disclosure, and outputting the locked or unlocked status of a deadbolt based upon information in the wireless transmission.

In general, in a fourth aspect, the disclosure features a method. The method can include fitting a device of the disclosure over a deadbolt lock turnpiece, turning the deadbolt lock turnpiece to lock or unlock a deadbolt operably linked to the deadbolt lock turnpiece, and generating a wireless transmission from the wireless transmitter.

Features of the devices, kits, and methods can include the following. The flexible material can have an oblong dimension and an opening capable of being stretched to accommodate a shape of the deadbolt lock turnpiece. The sensor and transmitter can be disposed on a printed circuit board, and the printed circuit board can be disposed on or within the flexible material. The sensor and transmitted can also not be disposed on a printed circuit board such that the sensor and wireless transmitter are disposed directly on or within the flexible material. The device can be battery powered. The device or kit can further include a magnet. The sensor can be a magnetometer designed to detect the magnet. The magnet can be disposed or placed on a deadbolt lock base. The magnet can be disposed or placed to align with a longitudinal axis of the deadbolt turnpiece when the deadbolt turnpiece is in a horizontal position, or align with a longitudinal axis of the deadbolt turnpiece when the deadbolt turnpiece is in a vertical position. The device or kit can include a printed circuit board, where the sensor and wireless transmitter are disposed on the printed circuit board. The sensor can be a bubble sensor. The wireless transmitter can be a BLUETOOTH® transmitter. The flexible material can include silicone, polyvinyl chloride, polyurethane, latex, synthetic rubber, natural rubber, or nitrile, or a combination thereof. The locked or unlocked status of the deadbolt can be outputted on a graphical user interface in text form or in symbol form, and alternatively or in addition, outputted in audio form. The time and date of the transmission from the transmitter can be outputted. A name or an identity of a door associated with a device of the disclosure can be inputted.

It should be understood that the devices, kits, and methods are not to be considered limitations on the invention defined by the claims. The featured devices, kits, and methods can be implemented in one or more ways using one or more features depicted in the drawings, described in the detailed description, and set forth in the claims. The featured devices, kits, and methods can be combined in one or more ways when implemented.

### BRIEF DESCRIPTION OF THE DRAWINGS

The accompanying drawings illustrate certain aspects and principles of the implementations set forth, and should not be construed as limiting.

FIGS. 1A-1E are diagrams showing various perspective views of a deadbolt turnpiece having a deadbolt turnpiece cover installed thereupon according to one implementation. FIGS. 1A and 1B are diagrams showing a top view of a deadbolt lock with deadbolt turnpiece cover installed thereupon as it would be perceived on a door from someone inside the door according to one implementation, with FIG. 1A showing the deadbolt turnpiece in a vertical unlocked position and FIG. 1B showing the deadbolt turnpiece in a horizontal locked position. FIGS. 1C and 1D are diagrams showing a front view (FIG. 1C) and a back view (FIG. 1D) of the deadbolt turnpiece in isolation with the deadbolt turnpiece cover installed. FIG. 1E is a diagram showing a side view of the deadbolt turnpiece with the deadbolt turnpiece cover installed.

FIG. 2 is a circuit diagram showing a configuration of a battery, printed circuit board (PCB), sensor, and transmitter according to one implementation.

FIG. 3 is a graphical user interface according to one implementation.

FIGS. 4A and 4B are flow charts depicting method steps according to implementations.

### DETAILED DESCRIPTION

Reference will now be made in detail to various illustrative implementations. It is to be understood that the following discussion of the implementations is not intended to be limiting.

In one aspect, the disclosure provides a universal door lock signaler device usable with common deadbolt mechanisms. The door lock signaler can be implemented as a deadbolt turnpiece (also known as a thumbturn) cover that detects whether a door lock turnpiece is in a locked state or an unlocked state. The deadbolt turnpiece cover can be implemented as a flexible sheath to fit a standard turnpiece for a deadbolt or other lock on most exterior residential doors. The flexible sheath can include a position sensing mechanism to sense when the lock is in a locked or unlocked position. Such sensing mechanism can include components to complete a circuit such as cooperating magnets located in the sheath and at the locked or unlocked position on the lock base. The universal deadbolt turnpiece cover works and can be retrofitted with existing, standard bolt hardware. The sheath can also include a wireless signal transmitter to send a signal when the turnpiece is either in the locked or unlocked position. The sheath can also include a battery to power the transmitter and/or the sensing mechanism. Also provided is an application executable on a computer or computing device, such as a mobile phone, that displays the locked or unlocked status of one or more doors where the device is installed, based on the wireless communication received from the universal deadbolt turnpiece cover.

Advantages of the deadbolt turnpiece cover device, only some of which are described herein, include relative simplicity in number of components, reduced cost compared to automatic door locking mechanisms, and universality as a result of the flexible material. As the cover retrofits seamlessly to existing manual deadbolt hardware, no tools, drilling, or low-voltage experience are required for installation. While comparable market security products are alarm based with much more permanent installation requirements, the universal turnpiece cover simply fits like a latex glove over the fixture and provides basic peace of mind.

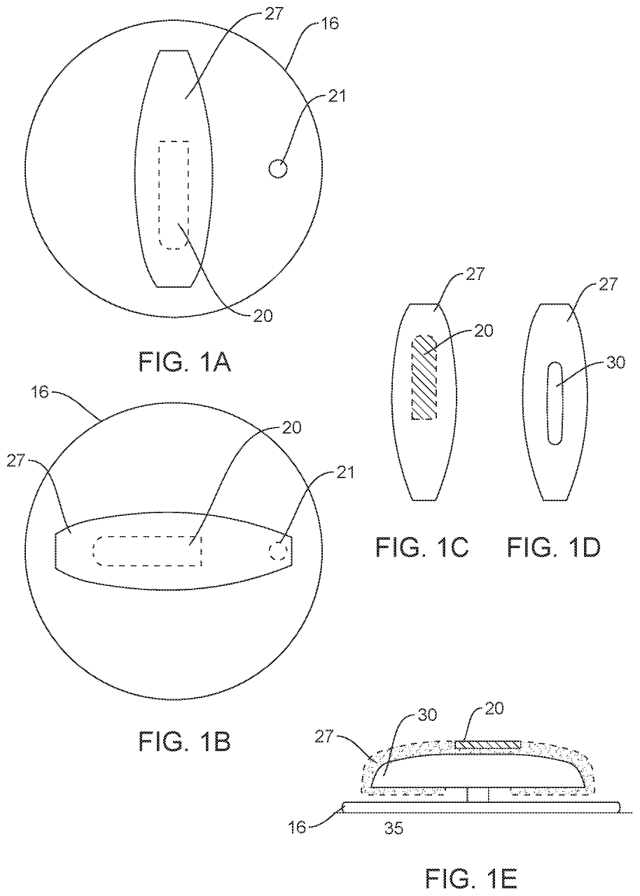

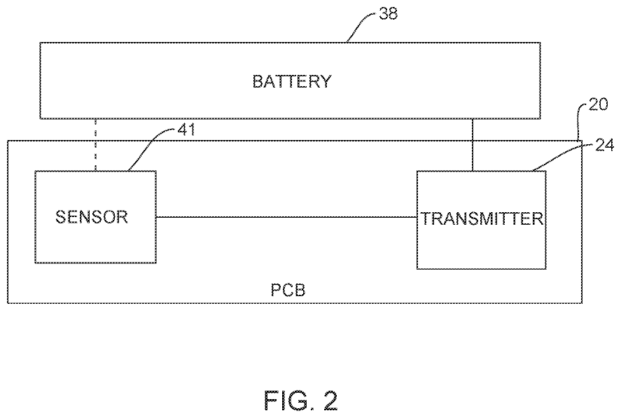

One implementation of a deadbolt turnpiece cover is shown in FIGS. 1A-1E. A deadbolt turnpiece 30 is connected to a deadbolt base 16 installed on a door surface 35, as shown in FIG. 1E. As shown in FIGS. 1A-1E, the deadbolt turnpiece 30 is covered with a flexible cover 27. The flexible cover 27 can be made of an elastic material which can include one or more flexible polymers, such as silicone, polyvinyl chloride, polyurethane, latex, synthetic rubber (Neoprene), natural rubber, or nitrile. The flexible cover 27 can have an oblong curvilinear (e.g., oval) or rectangular shape dimensioned to be slightly smaller than the length and width of conventional door deadbolt turnpieces. The flexible cover can be dimensioned to have an opening which can be fitted over a deadbolt turnpiece such that the cover can stretch and expand and cover the door turnpiece while leaving a minor portion (representing the opening) in the back of the turnpiece uncovered, as shown in FIG. 1D. Exemplary dimensions include a range of 1 inch to 2 inches long, including 1.1, 1.2, 1.3, 1.4, 1.5, 1.6, 1.7, 1.8, 1.9 inches long, 0.20 to 0.80 inches wide, including 0.25, 0.30, 0.35, 0.40, 0.45, 0.50, 0.55, 0.60, 0.65, 0.70, 0.75 inches wide, and 0.1 to 0.5 inches deep, including 0.2, 0.3, 0.4 inches deep. The flexible cover can be dimensioned to cover any shape of deadbolt turnpiece, including circular, oval, square, rectangular, or polygonal shape, or a combination of these. The flexible cover can be glove-like as described above to provide a tight fit through the elastic material, or can be implemented in other ways using other materials such as fabric, such as an adjustable sleeve that can be wrapped around the deadbolt turnpiece and tightened to fit the width of the turnpiece, much like a cuff. The flexible cover can include a printed circuit board (PCB) 20 disposed within or on either the front or back surface of the flexible cover. The PCB can have a position sensor installed which senses whether the turnpiece is in a locked or unlocked position. The position sensor can be a bubble sensor, a magnetic sensor (e.g., magnetometer), or other type of position sensor that determines whether the orientation of the deadbolt turnpiece is in a vertical unlocked position or a horizontal locked position. The magnetic sensor can detect a magnet 21 positioned on the deadbolt base 16 such that the position sensor moves in proximity to the magnet 21 when the deadbolt turnpiece is in a horizontal locked position (as shown in FIG. 1B) or vertical unlocked position. The magnet can be attached to the deadbolt base through magnetism or through adhesive means, such as double-sided adhesive tape, hook and loop fasteners with adhesive backing, or glue. Other types of position sensors that can be implemented in the device include potentiometric position sensors (resistance-based), inductive position sensors, eddy current-based position sensors, capacitive position sensors, magnetostrictive position sensors, hall effect-based magnetic position sensors, fiber-optic position sensors, optical position sensors, and ultrasonic position sensors. The PCB 20 can also include a wireless transmitter (BLUETOOTH®, WIFI) in communication with the position sensor for wirelessly communicating output from the position sensor. The flexible cover can also include a battery (not shown in FIGS. 1A-1E) for powering the transmitter and/or the sensor. The battery can be a lithium-ion battery of appropriate voltage and size, such as a 3-volt lithium coin battery. The sensor, transmitter, and/or battery can be imbedded within the flexible cover, or can be attached to either the front or the back of the flexible cover, either freely or on the PCB. The battery can also be mounted separately from the flexible cover, such as on the deadbolt base 16, using a separate mount, and attached to the PCB with electrical leads. These components are dimensioned to be sufficiently thin to be incorporated in any of these configurations. FIG. 2 shows a circuit diagram showing the operative electrical connections between the transmitter 24, battery 38, and position sensor 41. The transmitter 24 and position sensor 41 are disposed and connected together on the PCB 20; the battery 38 powers the transmitter 24 and optionally the sensor 41 (depending upon what type of sensor) through electrical contacts on the PCB 20. It should be noted that the configuration shown in FIG. 2 is just an illustrative example; the relative positions of the transmitter 24, battery 38, and position sensor 41 can differ when implemented within the flexible cover while providing the same electrical connectivity. Other implementations may not include the PCB such that the components are only connected by electrical contacts or leads such as wires. The sensor 41 sends a signal to the wireless transmitter 24 with respect to detected orientation of the deadbolt turnpiece. The wireless transmitter 24 transmits data to a computer or computing device indicating the orientation of the deadbolt turnpiece. The computer or computing device has an application installed that can decode the data transmission communicated by the wireless sensor and display the information the data conveys as to whether a door of the installed device has a locked or unlocked deadbolt.

The flexible deadbolt turnpiece cover can be used with existing bolt hardware for a manually operated bolt such that no new bolt hardware is required to be installed. The existing bolt hardware can include a conventional cylindrical casing, cylinder, keyhole, internal pins, thumbturn, and bolt or latch as would be found in most if not all manual deadbolt systems. The existing, conventional bolt hardware lacks electrical contacts, circuitry, a power source, sensors, processors, driveshafts, motors, gears and other components which would be included in an electronic deadbolt locking device. As the flexible deadbolt turnpiece cover serves as a standalone system for indicating the locked or unlocked status of a deadbolt, the complexity, cost, and educational training required for installation are dramatically reduced in comparison to electronic deadbolt locking devices; the flexible deadbolt turnpiece cover device can be installed by any consumer.

Another implementation provides a device or a kit which includes a piece of flexible material designed to fit over a deadbolt lock turnpiece, a sensor designed to detect whether the deadbolt lock turnpiece is in a horizontal or vertical position, and a wireless transmitter. The device or kit can include a magnet that can be applied to a deadbolt base such as through magnetic attraction in the case of a metallic deadbolt base. The device or kit can also include adhesive means for attaching the magnet, such as double-sided adhesive tape, hook and loop strips with adhesive backing, or glue. The device or kit can lack the flexible material in some implementations, such that the sensor and wireless transmitter are installed through other means, such as adhesive means, either as separate components or on a PCB. The device or kit can include a battery in some implementations.

Another implementation provides a system including a set of manual deadbolt hardware which includes a device or kit of the disclosure or one or more components thereof. The system can include a deadbolt turnpiece and a sensor and transmitter capable of being installed on or within the deadbolt turnpiece. The sensor and transmitter can be installed on a printed circuit board that can then be installed on or within the deadbolt turnpiece. The sensor and transmitter, or PCB including them, can be installed on the deadbolt turnpiece by way of the flexible cover, or through other suitable attachment apparatus, such as an adjustable sleeve that can be wrapped around the deadbolt turnpiece and tightened to fit the width of the sleeve, much like a cuff. In some implementations, the sensor and transmitter, or PCB including them, are preinstalled on or within the deadbolt turnpiece such that no flexible material or other attachment apparatus is present or required.

The following figure depicts an implementation of a graphical user interface of a downloadable application and/or a dedicated website capable of performing method implementations or portions thereof described herein. The graphical user interface will be described with respect to specific icons, fields, buttons, and other features which are displayed on a screen or display of a computer or computing device such as a mobile phone and are selectable by a user of the application and/or website by way of a touchscreen, trackpad, mouse, keyboard, or other input device such as a pen or stylus and provide for input. Selection of the icons and other features by a user activates certain method steps for performing various functions executable as computer program instructions on a stationary computer or portable computer/computing device. These computer program instructions may be provided to one or more processor(s) of a general-purpose computer, special purpose computer, or other programmable data processing device or combination of devices, such that the instructions, which execute via the processor or processors of the computer or other programmable data processing device(s), create means for implementing the method steps or portions thereof. As such, methods described herein or portions thereof can be performed as a series of steps which are implemented as computer-readable code, computer-readable instructions, computer-executable instructions, “application(s)”, or “software” performed by one or more processor(s). Such software can be loaded onto a memory or memories of a computer, portable computer/computing device, or system or combination thereof, as an application or program (or multiple applications and/or programs) capable of performing one or more steps of the method implementations. As can be appreciated, different steps or groups of steps of the method implementations can be performed by different computers or computing devices, or some or all can be performed by a single computer or computing device.

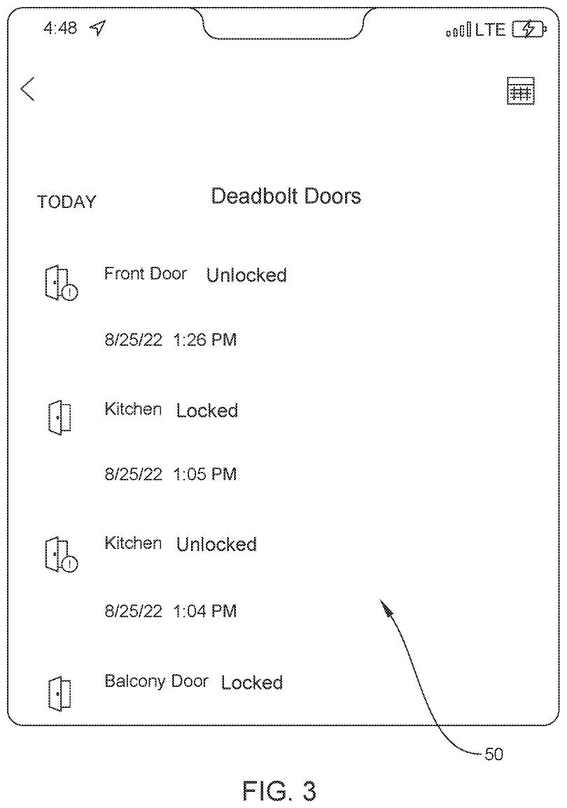

FIG. 3 shows a graphical user interface 50 of an application for a computer or computing device according to one implementation. The graphical user interface displays the name of each door on which the deadbolt turnpiece cover is installed, such as Front Door, Kitchen, etc., based on signals received from the transmitter from each deadbolt turnpiece cover device. The application can have functionality that allows the user to assign the name of the door that each deadbolt turnpiece cover is installed, based on the received wireless signal. The graphical user interface displays whether the received wireless signal indicates that the door deadbolt is locked or unlocked, in text format or as a graphical symbol. The graphical user interface also displays the time and date of the last transmission received from the wireless transmitter. The application can optionally include other functions such as an audible alarm that is played from a speaker of the computer or computing device when a deadbolt is left unlocked. The audible alarm can be customized to broadcast a different sound for each door. The audible alarm can also be implemented as a voice that conveys that a door deadbolt is left unlocked. The application outputs visual or auditory information to indicate the locked or unlocked status of the door deadbolt, and allows customization as to the form of the output, whether it be a graphical symbol, text, or audio. The application also allows naming of each deadbolt turnpiece cover device based on the door that it is installed on.

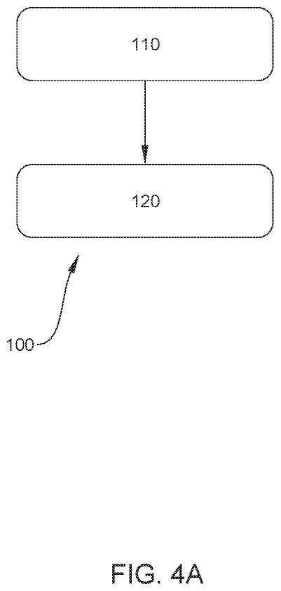

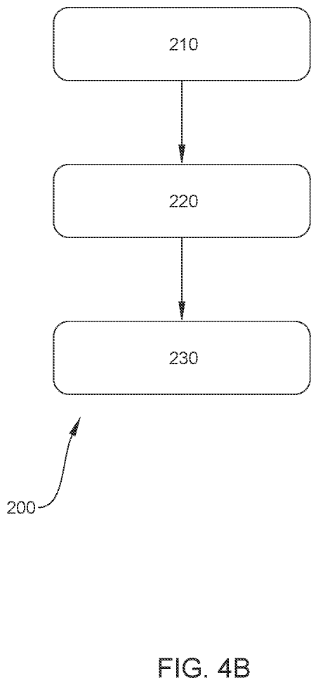

FIGS. 4A and 4B show representations of implemented methods according to the disclosure. One method 100 provides receiving a wireless transmission from the device of the disclosure 110, and outputting the locked or unlocked status of a deadbolt based upon information in the wireless transmission 120. Another method 200 provides fitting a device of the disclosure over a deadbolt lock turnpiece 210, turning the deadbolt lock turnpiece to lock or unlock a deadbolt operably linked to the deadbolt lock turnpiece 220, and generating a wireless transmission from the wireless transmitter 230. Method 200 can further include method 100 after the wireless transmission is generated.

As can be appreciated by those in the computer engineering arts, inputting steps can be performed through one or more input-output (I/O) interface on a fixed position computer or computers such as a desktop computer or server or on a portable computer/computing device or devices, such as a personal electronic device including a tablet, laptop, PDA, gaming device, or smartphone. Visual prompting can take the form of a message and/or input field provided to the user on a display. The input field can be provided as part of a graphical user interface provided on the display of a computer(s) or computing device(s) which provides one or more data entry fields, check boxes, buttons, toggles, sliders, or pull-downs which allow the user to input information such as a name designation of each deadbolt for each installed deadbolt turnpiece cover device. Auditory prompting can take the form of speech or a recording broadcast from a speaker which prompts the user to enter the information. Inputting steps can be performed through traditional inputting means such as a physical keyboard or a keyboard projected on a display, such as a touchscreen, or through a mouse or trackpad. The keyboard can be a QWERTY keyboard or a condensed keyboard commonly used in electronic devices such as cell phones. Inputting can also be performed through the user providing speech which is inputted through a microphone of the computer(s) or computing device(s) and recognized by speech recognition algorithms programmed on the computer or computing device. Outputting steps can be formed through a visual output device such as a display on the computer(s) or computing device(s) or a speaker of the computer(s) or computing device(s). The outputting step can display text, symbols, and/or sound indicating the locked or unlocked status of a deadbolt and the door in which it is installed.

Computer-executable code or instructions for performing method steps described or depicted herein or portions thereof can be implemented as software or an application capable of being run on the computer(s) or computing device(s). The computer-executable code or instructions can be installed on the computer(s) or computing device(s) during manufacture as software, or implemented as firmware or hardware (e.g., circuitry), or some combination of these. The computer-executable code or instructions can be configured to be downloadable onto the memory of the computer(s) or computing device(s) from a cloud storage source available on the Internet, such as an application retail source (e.g., “app store”) capable of being accessed from a mobile phone, tablet, laptop, gaming device, desktop computer, or other programmable device having components or features capable of performing the method steps described above. Examples of suitable internet-accessible sources include the Apple Store, Google Play, and other sites that make software applications and other downloads available for purchase or license. In addition to installation on the user's computer(s) or computing device(s), the computer-executable code or instructions can also be hosted on a server or servers accessible to users through a network connection, or can be distributed between a server and an application installed on a user's computer(s) or device(s).

The computer-readable code, computer-readable instructions, computer-executable instructions, or “software” can be organized into routines, subroutines, procedures, objects, methods, functions, or any other organization of computer-executable instructions that is known or becomes known to a skilled artisan in light of this disclosure, and can be programmed in any suitable programming language, including PHP, HTML, XML, XHTML, JavaScript, C, C #, C++, Java, Python, Perl, Ruby, Swift, Visual Basic, and Objective C. By such programming, the computer-readable code, computer-readable instructions, computer-executable instructions, “application” or “software” instruct one or more processors of the computer(s) or computing device(s) to carry out the operations and commands of the application. Inputted information related to the assigned identity of each door where each deadbolt turnpiece cover is installed can be stored in the computer(s) or computing device(s)'s memory with the computer executable instructions. The memory can be implemented through non-transitory computer-readable storage media such as RAM. As used in the context of this specification, a “non-transitory computer-readable storage medium (or media)” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM.

In one implementation, a computer system for performing the method steps includes 1) one or more computer that is located remotely from a user and connected to the Internet and to each other and 2) a computer or computing device accessible to the user that can communicate with the remote computer(s) through a network. The remote computer(s) can be a fixed position computer, and the user's computer or computing device can be fixed such as a desktop computer or mobile/portable. The user's computer or device can be a desktop computer, laptop, tablet, gaming device, PDA, or smartphone that can access or display the graphical user interface depicted in FIG. 3. The graphical user interface can be downloaded as part of an application from cloud storage services providing retail application downloading to the user's computer or computing device, or can be hosted on a remote computer which acts as a web server and accessed through the internet as webpages through an Internet browser on the user's computer or computing device. The methods need not be limited to one particular distribution of functions on a single computer or multiple computers; multiple configurations hosted on one or more computers are contemplated. In one implementation, the graphical user interface 50 shown in FIG. 3 is accessible through a webpage, and the information with respect to the locked and unlocked status of a door deadbolt is stored in a cloud relational database such as those provided by Oracle and/or hosted by Amazon Web Services. The application on the user's computer or computing device provides updates on the deadbolt status information continuously or at predetermined times. In this way, the user has a historical record of whether a door deadbolt has been locked or unlocked.

Additional embodiments include a computer, computing device, or system or combination thereof capable of carrying out the method and its implementations or portions thereof. The computer, computing device, system or combination thereof can include one or more processors capable of executing the computer-readable code, computer-readable instructions, computer-executable instructions, or “software”, one or more interface capable of providing input or output, one or more memories and a set of instructions (e.g., software) stored in a memory or memories of the computer, computing device, or system or combination thereof for carrying out the method. The computer, computing device, or system or combination thereof can include one or more stand-alone computer, such as a desktop computer, a portable computer or personal electronic device, such as a tablet, laptop, PDA, gaming device, or smartphone, or a set of computers or devices connected through a network including a client-server configuration and one or more database servers. The network can use any suitable network protocol, including IP, UDP, or ICMP, and may be any suitable wired or wireless network including any local area network, wide area network, Internet network, telecommunications network, Wi-Fi enabled network, or BLUETOOTH® enabled network. Other protocols include Hypertext Transfer Protocol (HTTP), extensible markup language (XML), extensible hypertext markup language (XHTML), or a Wireless Application Protocol (WAP) protocol. In this way, one or more steps of the methods can be distributed across the system or combination, or performed on only one computer or computing device, according to specific applications or designs.

Computers, computing devices, or systems thereof described herein can include a variety of components known in the art, including one or more processor, a volatile memory, a non-volatile memory, standard I/O interfaces such as a universal serial bus (USB) port, an HDMI or HDMI ARC port, an optical port, an ethernet port, and/or a serial port, a hard drive, a disk drive, a CD-ROM drive, a motherboard, a printed circuit board (PCB), circuitry for enabling a wireless connection or communication to another device, such as a BLUETOOTH® board, a Wi-Fi board, or a transmitter-receiver for mobile telecommunications, a data bus, an address bus, a control bus, and/or one or more user interface devices including a display, keyboard, keypad, trackpad, mouse, control panel, touch screen display, speaker, camera, and/or microphone. The computers, computing devices, or systems thereof can be equipped with an operating system implemented as software or firmware. As can be appreciated, the computers, computing devices, or systems may differ in their inclusion, exclusion, or configuration of components according to their individual applications or designs.

Another implementation provides a system including a device of the disclosure and a computer, computing device, or system thereof. The device of the system senses whether a door is locked or unlocked and transmits that information to the computer or computing device of the system, by way of the sensor and transmitter previously described. The computer or computing device of the system receives the information and displays the information on a graphical user interface. The system or device thereof can be used as follows. A user installs the device on a deadbolt turnpiece. The user then manually locks or unlocks the deadbolt of the door with the deadbolt turnpiece. The device detects whether the door deadbolt is locked or unlocked and transmits the information to the computer or computing device by way of a BLUETOOTH® connection between the device and the computer or computing device. The user accesses an application installed on the computer or computing device and then reads or sees the locked or unlocked status of the deadbolt on a graphical user interface of the application. This can be repeated with multiple installations of the device for different doors.

The present disclosure has described particular implementations having various features. In light of the disclosure provided above, it will be apparent to those skilled in the art that various modifications and variations can be made without departing from the scope or spirit of the disclosure. One skilled in the art will recognize that the disclosed features may be used singularly, in any combination, or omitted based on the requirements and specifications of a given application or design. When an implementation refers to “comprising” certain features, it is to be understood that the implementations can alternatively “consist of” or “consist essentially of” any one or more of the features. Other implementations will be apparent to those skilled in the art from consideration of the specification and practice of the disclosure.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the disclosure fall within the scope of the disclosure. Further, all of the references cited in this disclosure including patents, published applications, and non-patent literature are each individually incorporated by reference herein in their entireties and as such are intended to provide an efficient way of supplementing the enabling disclosure as well as provide background detailing the level of ordinary skill in the art.

1. A device, comprising:
flexible material designed to fit over a deadbolt lock turnpiece;
a sensor designed to detect whether the deadbolt lock turnpiece is in a horizontal or vertical position; and
a wireless transmitter operatively connected to receive output from the sensor.

2. The device of claim 1, wherein the flexible material has an oblong dimension and an opening capable of being stretched to accommodate a shape of the deadbolt lock turnpiece.

3. The device of claim 1, wherein the sensor and transmitter are disposed on a printed circuit board, and the printed circuit board is disposed on or within the flexible material.

4. The device of claim 1, wherein the sensor and transmitted are not disposed on a printed circuit board, and the sensor and wireless transmitter and disposed directly on or within the flexible material.

5. The device of claim 1, wherein the device is battery powered.

6. The device of claim 1, further comprising a magnet, wherein the sensor is a magnetometer designed to detect the magnet.

7. The device of claim 6, wherein the magnet is disposed on a deadbolt lock base.

8. The device of claim 7, wherein the magnet is disposed to align with a longitudinal axis of the deadbolt turnpiece when the deadbolt turnpiece is in a horizontal position.

9. The device of claim 7, wherein the magnet is disposed to align with a longitudinal axis of the deadbolt turnpiece when the deadbolt turnpiece is in a vertical position.

10. The device of claim 1, wherein the sensor is a bubble sensor.

11. The device of claim 1, wherein the wireless transmitter is a Bluetooth transmitter.

12. The device of claim 1, wherein the flexible material comprises silicone, polyvinyl chloride, polyurethane, latex, synthetic rubber, natural rubber, or nitrile, or a combination thereof.

13. A kit, comprising:
flexible material designed to fit over a deadbolt lock turnpiece;
a sensor designed to detect whether the deadbolt lock turnpiece is in a horizontal or vertical position; and
a wireless transmitter.

14. The kit of claim 13, further comprising a printed circuit board, wherein the sensor and wireless transmitter are disposed on the printed circuit board.

15. The kit of claim 13, further comprising a magnet.

16. A method, comprising:
receiving a wireless transmission from the device of claim 1; and
outputting the locked or unlocked status of a deadbolt based upon information in the wireless transmission.

17. The method of claim 16, wherein the locked or unlocked status of the deadbolt is outputted on a graphical user interface in text form or in symbol form.

18. The method of claim 16, wherein the locked or unlocked status of the deadbolt is outputted in audio form.

19. The method of claim 16, further comprising outputting the time and date of the transmission.

20. The method of claim 16, further comprising inputting a name or an identity of a door associated with the device of claim 1.
